(19) United States
(12) Patent Application Publication
(10) Pub. No.: US 2002/0109675 A1
(43) Pub. Date: Aug. 15, 2002

(54) Keyboard incorporating memory card reading device

(76) Inventor: Yen Liang Kuan, Jia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/781,262

(22) Filed: Feb. 13, 2001

(51) Int. Cl. G09G 5/00

(52) U.S. Cl. 345/168

(57) ABSTRACT

A computer keyboard includes a casing in which a keyboard circuit is arranged. A USB-based memory card reading device is also arranged inside the casing for reading a memory card, such as a memory stick card and a security digital memory card, received in a card receiving slot defined in the casing. A USB controller is mounted inside the casing and connected to both the keyboard circuit and the memory card reading device. The USB controller is connected to a computer by a USB keyboard cable for transmission of signals from the keyboard circuit and the memory card reading device to the computer. A USB hub may be selectively mounted inside the casing and connected to the USB controller for connection with other USB-based peripheral devices.

### FIELD OF THE INVENTION

The present invention generally relates to a computer keyboard, and in particular to a USB (Universal Serial Bus) based computer keyboard with a USB-based memory card reading device incorporated therein.

### BACKGROUND OF THE INVENTION

Computers have been widely used in processing, storing and transmitting data and information. A computer system includes a number of peripheral devices, including input/output devices and data storage. Commonly used data storage is a memory card, which provides a computer system with extra storage spaces. A memory card can be read by a memory card reading device which includes an interface circuit for connection and communication with the computer system.

In a computer system incorporating USB (Universal Serial Bus) based transmission interface, each USB-based peripheral device requires a USB connection with the computer system. For example, a USB-based keyboard and a USB-based memory card reading device need two separate USB connections with the computer system. The USB connection of a computer system is usually in the form of a socket mateable with a USB plug of a USB-based peripheral device. Thus the USB connection that a computer system can provide is limited. This in turn limits the number of the peripheral devices that can be connected to the computer system.

A hub may be used in a USB-based system to increase the number of the peripheral devices that can be connected to a computer system. This, however, increases the overall costs of the computer system.

### SUMMARY OF THE INVENTION

Accordingly, an object of the present invention is to provide a computer peripheral device comprising a keyboard in which a memory card reading device is incorporated whereby the peripheral device serves as both an input device and a storage device.

Another object of the present invention is to provide a USB-based computer keyboard incorporating a USB-based memory card reading device wherein both the keyboard and the memory card reading device share the same USB controller so that no additional interface circuit is required for the memory card reading device thereby reducing the costs.

A further object of the present invention is to provide a USB-based computer keyboard incorporating a memory card reading device whereby the number of connections with a computer system may be reduced.

To achieve the above objects, in accordance with the present invention, there is provided a computer keyboard comprising a casing in which a keyboard circuit is arranged. A USB-based memory card reading device is also arranged inside the casing for reading a memory card, such as a memory stick card and a security digital memory card, received in a card receiving slot defined in the casing. A USB controller is mounted inside the casing and connected to both the keyboard circuit and the memory card reading device. The USB controller is connected to a computer by a USB keyboard cable for transmission of signals from the keyboard circuit and the memory card reading device to the computer. A USB hub may be selectively mounted inside the casing and connected to the USB controller for connection with other USB-based peripheral devices.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a computer keyboard constructed in accordance with a first embodiment of the present invention;

FIG. 2 is system block diagram of the computer keyboard of the present invention; and

FIG. 3 is a perspective view of a computer keyboard constructed in accordance with a second embodiment of the present invention.

### DETAILED DESCRIPTION OF THE PREFERRED EMBODIMENTS

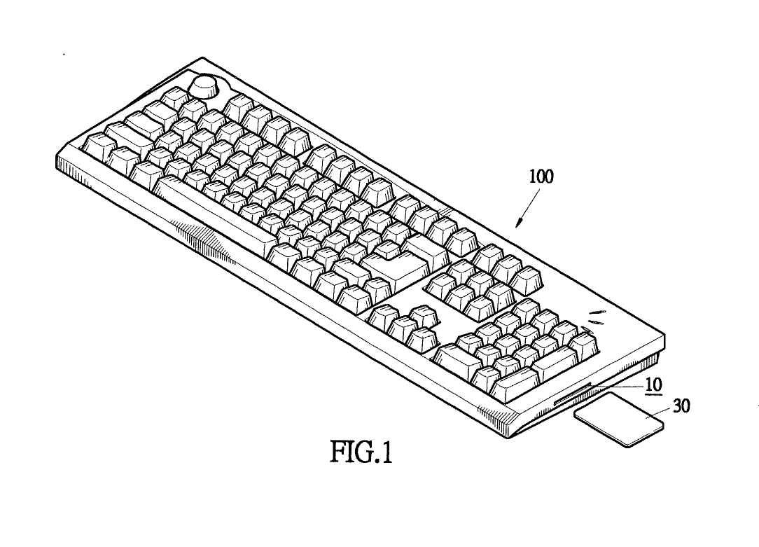

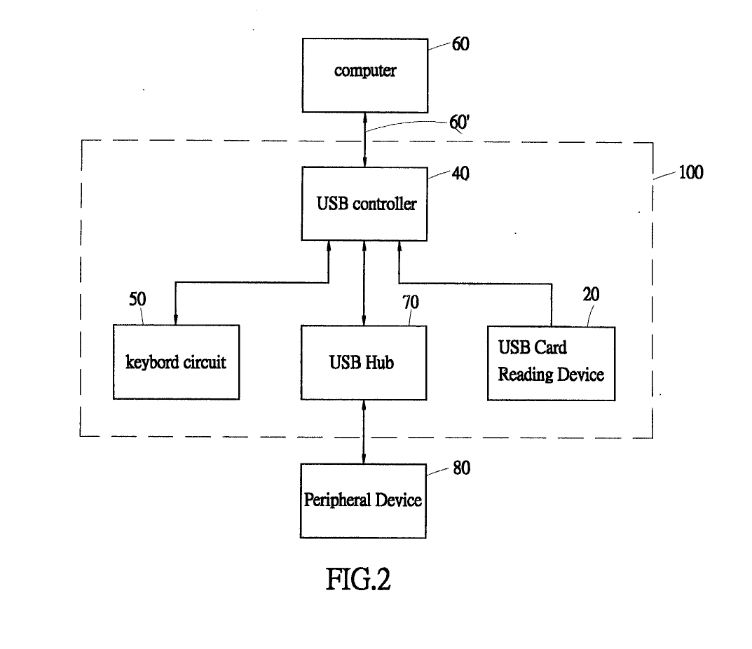

With reference to the drawings and in particular to FIGS. 1 and 2, a computer keyboard constructed in accordance with the present invention, generally designated with reference numeral 100, is shown, the keyboard 100 is a USB (Universal Serial Bus) based device. The keyboard 100 comprises a casing (not labeled) having front and rear edges connected by two lateral edges. Similar to a regular keyboard, a plurality of pushbuttons (not labeled) are formed on the keyboard 100 and a conventional keyboard circuit 50 is arranged inside the casing for transmitting signals corresponding to the depression of the pushbuttons from the keyboard 100 to a computer system 60. This is well known and will not be further described.

A slot 10 is defined in one of the lateral edges for receiving a memory card 30. The memory card 30 may be a memory stick card or a security digital memory card or other memory cards. A USB-based memory card reading device 20 is arranged in the casing for reading the memory card 30 received in the slot 10.

A USB controller 40 is arranged inside the casing of the keyboard 100. The USB controller 40 is connected to both the keyboard circuit 50 and the USB-based memory card reading device 20 for transmission of signals from the keyboard circuit 50 and the card reading device 20 to the computer system 60 by means of multiplexing operation and USB data transmission fashion. A USB keyboard cable 60′ is connected between the keyboard 100 and the computer system 60 for the transmission of the signals.

If required, a USB hub 70, in the form of a circuit, may also be incorporated in the computer keyboard 100. The hub 70 is also connected to the USB controller 40. This allows other USB-based peripheral devices 80 to be connected to the computer 60 via the keyboard 100. In addition, data transmitted from the memory card 30 to the computer 60 may be transmitted to the peripheral device 80.

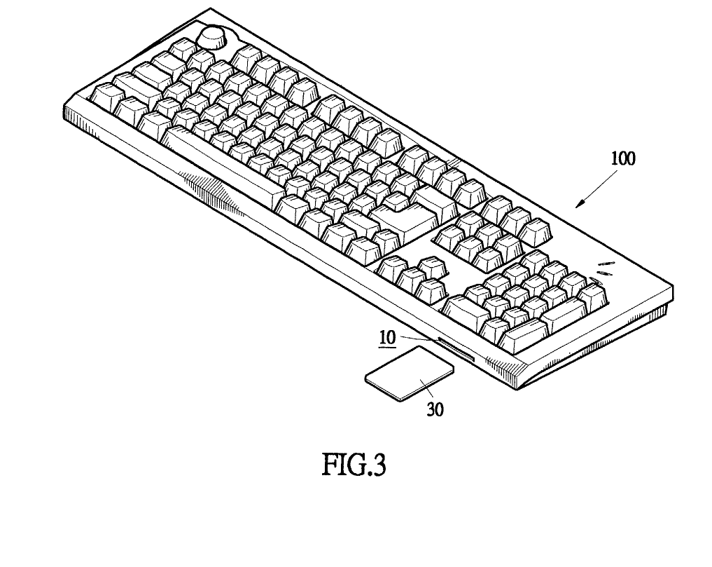

FIG. 3 shows a second embodiment of the present invention wherein the card receiving slot 10 is defined in the front edge of the keyboard casing to allow easy insertion of the memory card 30.

It can be understood from the above description that the keyboard of the present invention provides at least the following advantages:

(1) The space occupied by peripheral devices that are directly connected to a computer is reduced. In other words, by incorporating a memory card reading device in a keyboard, the space required by a separate memory card reading device is eliminated. Furthermore, no additional cabling is required for the separate memory card reading device.

(2) One single USB controller is sufficient for controlling both a keyboard and a memory card reading device. No additional interface circuit is needed. This saves the costs of the memory card reading device.

(3) The number of connections of peripheral devices with a computer is reduced. No additional hub is needed.

Although the present invention has been described with reference to the preferred embodiments thereof, it is apparent to those skilled in the art that a variety of modifications and changes may be made without departing from the scope of the present invention which is intended to be defined by the appended claims.

What is claimed is

1. A computer peripheral device comprising:
a keyboard comprising a casing inside which a keyboard circuit is formed, the casing having at least one edge in which a slot is defined;
a USB-based memory card reading device arranged inside the keyboard casing adapted to read a memory card received in the slot; and
a USB controller arranged inside the keyboard casing and connected to the keyboard circuit and the memory card reading device, the USB controller being adapted to connect to a computer system for transmission of the signals from the keyboard circuit and the memory card reading device to the computer system.

2. The computer peripheral device as claimed in claim 1, wherein the casing has a lateral edge in which the slot is defined.

3. The computer peripheral device as claimed in claim 1, wherein the casing has a front edge in which the slot is defined.

4. The computer peripheral device as claimed in claim 1, wherein the USB controller is connected to a USB keyboard cable which is adapted to connect to the computer system.

5. The computer peripheral device as claimed in claim 1 further comprising a USB hub arranged inside the casing and connected to the USB controller.
